(19) United States
(12) Patent Application Publication
(10) Pub. No.: US 2006/0049246 A1
(43) Pub. Date: Mar. 9, 2006

(54) System and method for calculating a car value using a smart card

(76) Inventor: Jung-Hwan Lee, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/149,811

(22) Filed: Jun. 9, 2005

(30) Foreign Application Priority Data
Jun. 9, 2004 (KR) 2004-0042262

(51) Int. Cl. G07B 15/02

(52) U.S. Cl. 235/384

(57) ABSTRACT

A system for calculating a car value includes a smart card control unit included in a car and loads a smart card, configured to derive a driving information, a diagnostic information and a maintenance information from electronic/mechanical control equipments and sensors of the car, and to store the driving information, the diagnostic information and the maintenance information on a smart card; a PC which is connected to a communication network by inserting the smart card to a terminal in the PC; and a car value calculating server connected to the communication network, configured to calculate the car value of the car on the basis of the driving information, the diagnostic information and the maintenance information, wherein the PC transmits the driving information, the diagnostic information and the maintenance information of the car to the car value calculating server through the communication network.

### CLAIM FOR PRIORITY

This application claims priority to Korean Patent Application No. 2004-42262 filed on Jun. 9, 2004 in the Korean Intellectual Property Office (KIPO), the entire contents of which are hereby incorporated by reference.

### BACKGROUND OF THE INVENTION

1. Field of the Invention

The present invention relates generally to a system and method for calculating a car value using a smart card, and more particularly, to a car value calculating system and method for calculating a reasonable car value using a smart card storing information on driving, diagnosis, maintenance and accident history of a car.

2. Description of the Related Art

According to the conventional car value calculation method used by the second-hand car dealers, car values are calculated mechanically based mainly on the year, mileage, and condition of the exterior of a car.

However, such a method has the drawback that it does not fully reflect the accurate conditions of a car and does not use objective factors in price computation of a car value.

That is, for a reasonable car value calculation, it would be preferable to apply the following various factors to the car value calculation and further collect and use such data.
a) Analysis of the mileage of a car based on a short-distance or long-distance travel (even though two cars have the same mileage, a car with a record of lots of long-distance travel on the highways has far better car conditions than a car with only a short-distance travel)
b) Analysis of the car diagnostic information for any defects
c) Analysis of the history on the vehicle parts exchanges and car maintenance to see the driver's maintenance history of the car; and
d) Analysis of damage due to car accidents.

However, under the conventional method, it is difficult to accurately and objectively use the above factors.

The present invention is to solve such problems of the prior art, characterized in that information on the driver's driving disposition, car diagnosis, driving, and accident history is recorded on a smart card, and by using the above information recorded on the smart card at the time of calculating the car value, a reasonable car value calculating system and method is realized.

An application for a system related to the smart card and the smart card control unit for cars which are used in the present invention was filed (with the Korean Intellectual Property Office) by the applicant of the present invention on Nov. 23, 2001, and was disclosed in details in Korean Patent Application No. 2001-73195 entitled “System And Method For Collecting Vehicle Data And Diagnosing A Vehicle, And Method For Automatically Setting The Vehicle Convenience Apparatus Using Smart Card.”

The present invention relates to an improved invention using a car data collection and diagnostic system for calculating a car value by the technology of the above patent invention. All the disclosures in Korean Patent Application No. 2001-73195 are included in the specification of the present invention as a reference.

The car data collection and diagnostic system published in the above Korean Patent Application is briefly described based on FIG. 1 as follows.

FIG. 1 is a block diagram showing a schematic structure of a car data collection and diagnosis system of the prior art.

Referring to FIG. 1, the car data collection and car diagnostic system 10 of the above patent invention includes a smart card control unit (SCU) 22 installed in a car 20, which transmits information through the medium of a smart card 30 and a main server at the central A/S center 60 which receives car-related information from a terminal of a body shop 40 or a personal terminal 50 through a network 70 and transmits car diagnostic and maintenance information back to the terminal of a body shop 40 or to the personal terminal 50.

The car 20 is installed with the SCU 22, and the SCU 22 collects the latest information on whether or not the car is in good condition indicated with error codes and on the changes of the car indicated with input values such as emission controlled module, injector actuating signal, etc. from electronic/mechanical control equipments and sensors installed in many apparatuses of the car, and then records the collected information in the internal memory and after that, collects the latest car maintenance information from the smart card 30, updates the internal memory and records them on the smart card 30.

Also, the control equipment of the car such as TCU (Transmission Control Unit) and ECU (Engine Control Unit) and sensors are connected to the SCU 22 in a parallel or serial manner, and all the data collected from each control equipment which are related to the car 20, for example, whether or not the electronic control equipment works properly, how often vehicle parts are exchanged and whether or not the engine works properly, are transmitted to the SCU 22 and stored in the internal memory of the SCU 22 as well as on the smart card 30.

On the other hand, the terminal of a body shop 40 includes a card reader which reads car-related data from the smart card 30 and records it on the smart card 30, and a computer connected to the card reader, which analyzes data read from the smart card 30, checks the conditions of the car and its exchanged vehicle parts and inputs and stores the maintenance information of the car to the smart card 30.

The personal terminal 50 includes a card reader which reads car-related data from the smart card 30 and records it on the smart card 30, and a computer connected to the card reader, where a maintenance program is installed that allows the computer to diagnose the car conditions and to indicate desired maintenance off-line, thus making self-examinations possible.

On the other hand, the main server at the central A/S center 60 is connected to the computer or communication terminal devices of the terminal of a body shop 40 and/or the personal terminal 50 through the network 70 such as the Internet.

### SUMMARY OF THE INVENTION

Accordingly, the present invention provides a system and method of using car-related information recorded and collected by a smart card according to the car data collection and diagnostic system of said patent invention to calculate the value of a car.

Embodiments of the present invention provide a more reasonable car value calculating system and method by using data such as driver's driving disposition, diagnostic information, maintenance and accident histories of a car for the factors to calculate a car value.

Embodiments of the present invention also provide a system and method for obtaining the above information with ease by a smart card control unit installed in a car and a smart card recording information from the said smart card control unit and then transmitting said information back to a car value calculating server after being connected to a car value calculating server through the smart card.

In some embodiments, a car value calculating system includes a smart card control unit which is included in a car and loads a smart card, configured to derive a driving information, a diagnostic information and a maintenance information from electronic/mechanical control equipments and sensors of the car, and to store the driving information, the diagnostic information and the maintenance information on a smart card; a PC which is connected to a communication network by inserting the smart card to a terminal in the PC; and a car value calculating server which is connected to the communication network, configured to calculate the car value of the car on the basis of the driving information, the diagnostic information and the maintenance information, wherein the PC transmits the driving information, the diagnostic information and the maintenance information of the car to the car value calculating server through the communication network.

The maintenance information of the car may be stored on the smart card by a terminal apparatus of a body shop where the car is repaired. The accident history of said car may be stored on the smart card, characterized in that the value calculation of the car is based on the accident history.

The driving information may include at least one of the mileage data, the driving time data, and the driving speed data such as the average speed, sudden acceleration, sudden deceleration, or over speed.

The diagnostic information may include information on whether or not various kinds of apparatuses in the car are in good condition.

The maintenance information may include the maintenance history on the exchange of expendable vehicle parts and/or spare parts.

The value calculation of the car may be carried out by comparing the driving information, the diagnostic information and the maintenance information of the car stored on the smart card with specific standard values.

In other embodiments, a method for calculating a car value includes inserting a smart card into a terminal of a PC and connecting a car value calculating server through a communication network, whereon a smart card stores a driving information, a diagnostic information and a maintenance information of a car; transmitting the driving information, the diagnostic information and the maintenance information to the car value calculating server by the PC; and calculating the car value on the basis of the driving information, the diagnostic information and the maintenance information by the car value calculating server.

According to above exemplary embodiments of the present invention, a more reasonable car value calculation can be realized by using information on the driver's driving disposition, car diagnosis and car maintenance and accident history. Also, a car value is calculated according to the information on a driver's driving disposition and maintenance habit, and thus, a more accurate and objective calculation of a car value is made possible.

Further, since a car value calculation is automatically carried out with the use of a smart card without a manual input of the applicant requesting the car value calculation, from the applicant's point of view, the system and method according to the present invention provides a more convenient way of confirming information on cars. Also, the car value information applets installed on a smart card for cars permits an accurate check on the accident history of a car.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a block diagram showing a schematic structure of a car data collection and diagnosis system of the prior art;

FIG. 2 is a block diagram showing an internal structure of a smart card control unit according to the present invention;

FIG. 3 is a flow chart showing a process of recording driving and diagnostic information of a car on a smart card according to the present invention;

FIG. 4 is a flow chart showing the process of recording car maintenance information on a smart card according to the present invention;

FIG. 5 is a flow chart showing a process of recording information on a car accident handling history on a smart card according to the present invention;

FIG. 6 is a block diagram showing a schematic structure of a system for calculating a car value according to the present invention;

FIG. 7 is a flow chart showing a process of calculating a car value according to the present invention; and

FIG. 8 is a drawing illustrating applets stored on a smart card according to the present invention.

### DESCRIPTION OF EMBODIMENTS

Detailed illustrative embodiments of the present invention are disclosed herein. However, specific structural and functional details disclosed herein are merely representative for purposes of describing exemplary embodiments of the present invention. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

Before explaining a car value calculating method of the present invention, a smart card control unit is described, which records car-related information on the smart card according to the present invention or updates the maintenance information from the smart card.

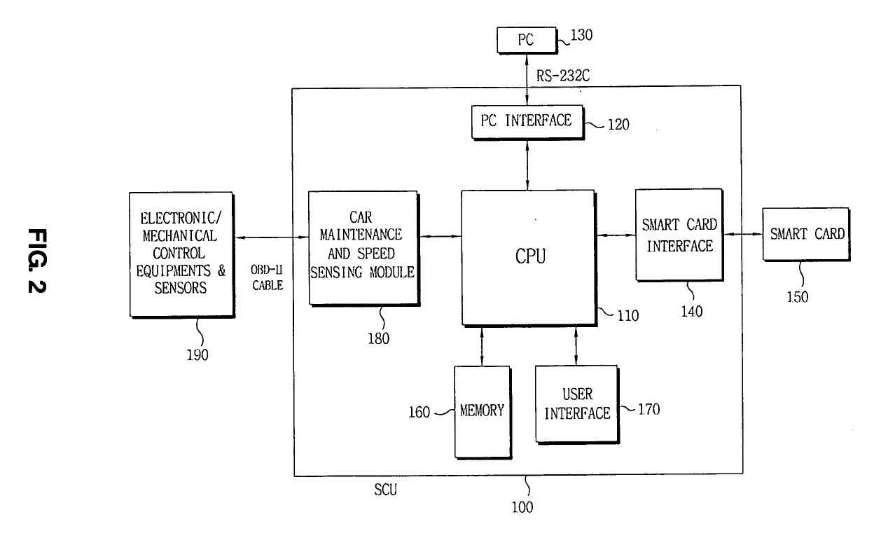

FIG. 2 is a block diagram showing an internal structure of a smart card control unit according to the present invention.

Referring to FIG. 2, the smart card control unit 100 according to the present invention includes CPU 110, PC interface 120, smart card interface 140, memory 160 such as RAM and EEPROM, user interface 170, and car maintenance and speed sensing module 180.

According to a preferred embodiment of the present invention, the CPU 110 may be a T89C51C101, an 8 bit 8051-core based CPU, and may perform an overall controlling process of the smart card control unit 100.

The PC interface 120 may be connected to the PC 130 for an outside supervisor through an RSC-232C serial port and may perform an interface function between the smart card control unit 100 for the installation and change of the program of the smart card control unit 100 and the PC 130.

The smart card interface 140 inputs car-related and driving disposition information on the smart card 150, and also, reads the latest maintenance information from the smart card 150 and updates the latest maintenance information. The smart card interface 140 includes a smart card reader (for example, TDA8029) which reads the smart card 150 and transmits the read information to the CPU 110. The smart card 150 may be a smart card for cars that have a security algorithm such as RSA, SHA-1, DES, and Triple-DES, protects the personal information of a cardholder and the car-related information and prevents their improper outflow/leak.

The smart card interface 140 performs the following functions; i) judging the legitimacy of an inserted smart card and preventing the improper use of the smart card, ii) recording the total mileage of the car and mileages according to each individual user of the car, etc. on the smart card, iii) recording the driver's driving disposition such as the maximum and minimum speeds, the average speed, sudden acceleration and sudden deceleration on the smart card on a regular basis, and iv) recording the error codes of the car (in this case, the error codes can provide basic analytical data by recording the time, speed and rpm of the car having an error at the time of its occurrence).

The memory 160 of the smart card control unit 100 may include a RAM which temporarily stores the collected diagnostic or maintenance information of the car, collected from the smart card, a ROM which stores a program for controlling the CPU 110, an EEPROM which stores some unique basic information and other information on the diagnosis, driver's driving disposition and maintenance of the car collected from the smart card, etc.

The user interface 170 may provide users with basic driving information of a car (car speed, RPM, mileage) and the working conditions of the smart card control unit 100. The user interface 170 may be embodied with LCD or LED, etc. Also, the user interface 170 may alarm users when hazardous errors/defects occur or when maintenance is required.

According to the preferred embodiments of the present invention, electronic mechanical control equipments and sensors 190 installed in the car such as ECU, TCU, ECS, ABS, and air bag, etc., are connected to a vehicle diagnosis and speed sensing module 180 inside the smart card control unit 100 through the OBD-II cable, and communication between them is performed by K-LINE and L-LINE, which is the communication protocol for the information exchange of vehicles in accordance with ISO 9141-2.

The car maintenance and speed sensing module 180 obtains error codes from ECU, TCU, ECS, ABS, and air bag, and the information on newly occurred error code is recorded on the smart card 150 through the smart card interface 140. Also, the module 180 may obtain a more elaborate and objective driver's driving disposition because the module 180 obtains various information on an engine such as RPM and temperatures from ECU, than the method of obtaining information on a driver's driving disposition simply from the car speed. In addition, the module 180 continues to monitor the driving speed of the car such as maximum-minimum speeds, average speed, sudden acceleration and sudden deceleration, and then records it on the smart card 150 through the smart card interface 140 on a regular basis.

The smart card control unit 100 may also include an RTC (Real Time Clock). The RTC is a digital electronic clock and used for generating data on the time when driving disposition and errors occur.

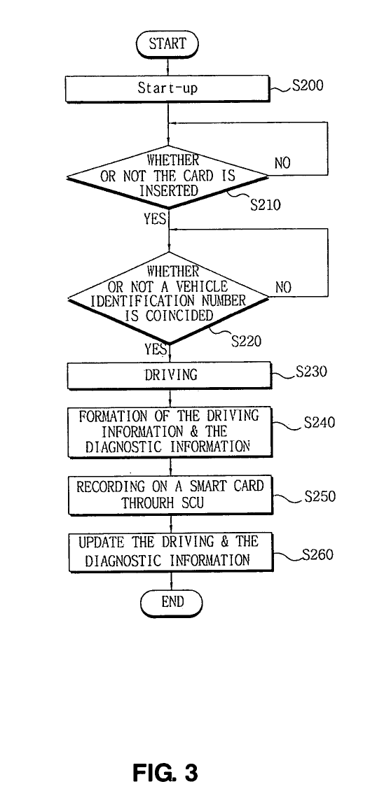

FIG. 3 is a flow chart showing a process of recording the driving and diagnostic information of a car on a smart card according to the present invention.

Referring to FIG. 3, the process of recording the driving information (or the driver's driving disposition information) and diagnostic information of the car on the smart card is explained.

First, when a driver starts his or her car at the stage S200, the smart card control unit decides whether a smart card for the car is inserted at the stage S210.

If the smart card is inserted into the smart card control unit, the smart card control unit decides whether the driver's vehicle identification number is identical to that of the smart card at the stage S220. This process is a process for confirming that the inserted smart card belongs to the right car.

In this process, if the smart card is not inserted, or if the vehicle identification number does not correspond with that of the card, the car does not work. If a card is inserted and the vehicle identification number is identical to that of the card, the car works normally at the stage S230.

Upon driving the car, driving and diagnostic information of the car are generated at the stage S240. That is, the driving information of the car includes driving speed data such as average speed, sudden acceleration, sudden deceleration and over speed; driving distance data such as short-distance or long-distance driving, and driving time data such as daytime or nighttime driving. Such driving information can be stored on the smart card control unit by the hour. Also, a variety of diagnostic information of the car is generated from the various electronic mechanical control devices and sensors of the car, and this is stored on the smart card control unit as error code.

Likewise, driving and diagnostic information of the car collected by the smart card control unit is stored on the smart card at the stage S250, and accordingly, driving and diagnostic information stored on the smart card is updated at the stage S260.

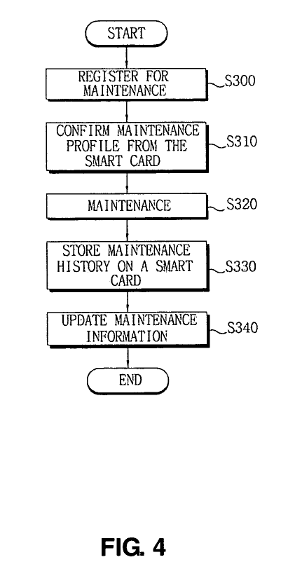

FIG. 4 is a flow chart showing a process of recording the car maintenance information on a smart card according to the present invention.

Referring to FIG. 4, the process of recording the car maintenance information (for example, vehicle parts exchanges) on the smart card is explained.

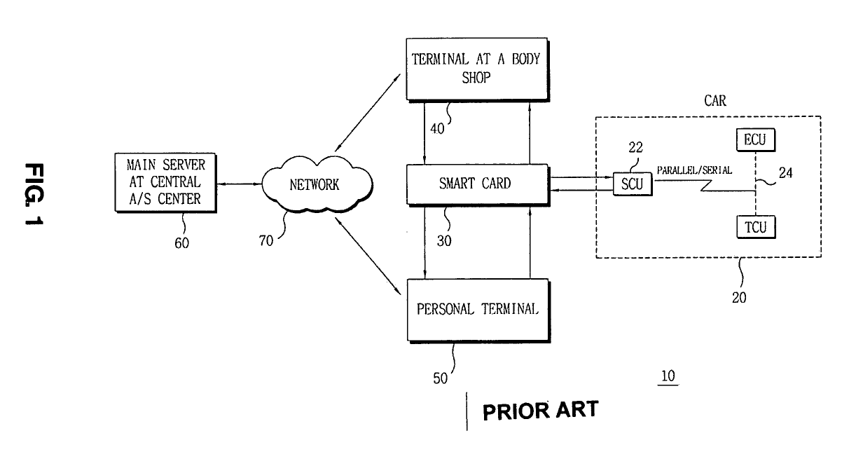

Referring again to FIG. 4, a driver takes his car to a body shop at the stage S300. Here, the body shop is equipped with a terminal for body shops that can read a smart card for cars according to the present invention and record said smart card information (reference numeral 40 of FIG. 1).

At the body shop, the smart card of the driver is read, and the maintenance history is checked at the stage S310. The maintenance history includes information on spare parts and other vehicle parts exchanges.

After the maintenance (parts exchange included) at the stage S320, the body shop stores the performed maintenance on its smart card by using the terminal at the stage S330 at the body shop, and maintenance information of the car on the smart card is updated at the stage S340.

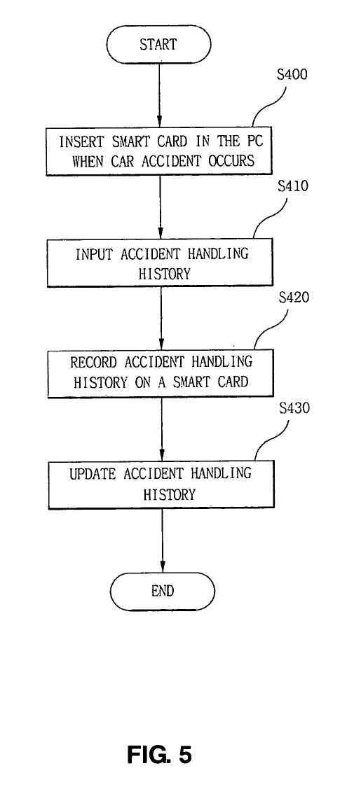

FIG. 5 is a flow chart showing a process of recording the information of a car accident history on the smart card according to the present invention.

Referring to FIG. 5, the process of recording the information of the car accident history on the smart card will be explained.

Referring again to FIG. 5, when a car accident occurs, a smart card from the smart card control unit of a driver's car is inserted into a PC at the stage S400. The PC can be either a PC in the hospital or police station, but there is no restriction on this matter.

Then, the person who is responsible to input information on how to handle the accident stores information at the stage S410 on how the accident has been handled (including the extent of the damage of the car and repair information), which is then recorded and stored on the smart card in the PC at the stage S420, and the accident history of the car on the smart card is updated at the stage S430.

As shown in the above process, according to the present invention, a car owner cannot manipulate the accident history of the car; and, buyers of a used car can have information on an accident history accurately and objectively. Also, the information on whether an accident actually has occurred and how serious the accident recorded in the hospital or the police station was can be confirmed through comparing the data with maintenance information of the car at the body shop.

Hereinafter, a calculation of a car value according to the present invention will be explained in detail.

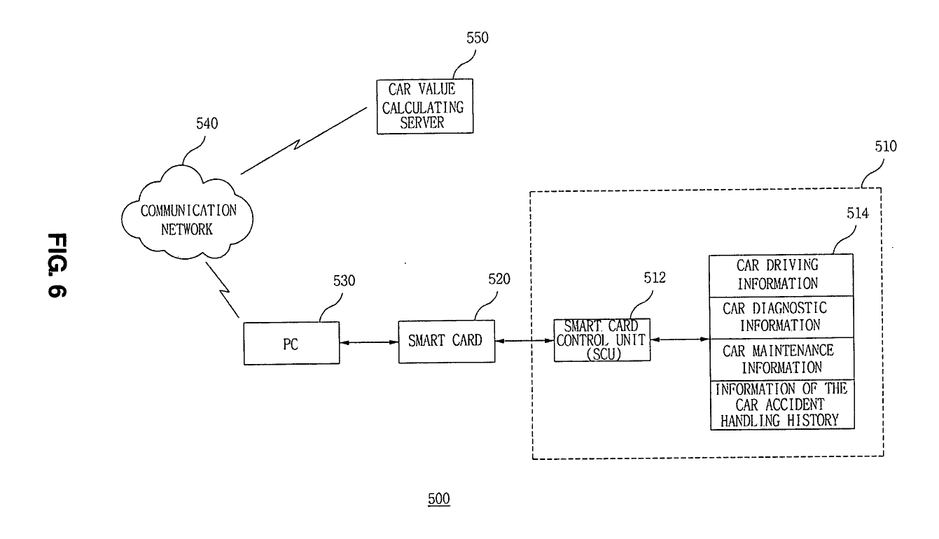

FIG. 6 is a block diagram showing a schematic structure of the system for calculating a car value according to the present invention.

Referring to FIG. 6, the car value calculating system 500 according to the present invention includes a car 510 installed with a smart card control unit 512, a smart card 520 which records information on driving, diagnostic, maintenance and car accident history 514 (by the processes of FIGS. 3 through 5) through the PCs in the body shop or hospital, etc., a PC 530, and a car value calculating server 550 connected through the PC 530 and communication network such as internet 540.

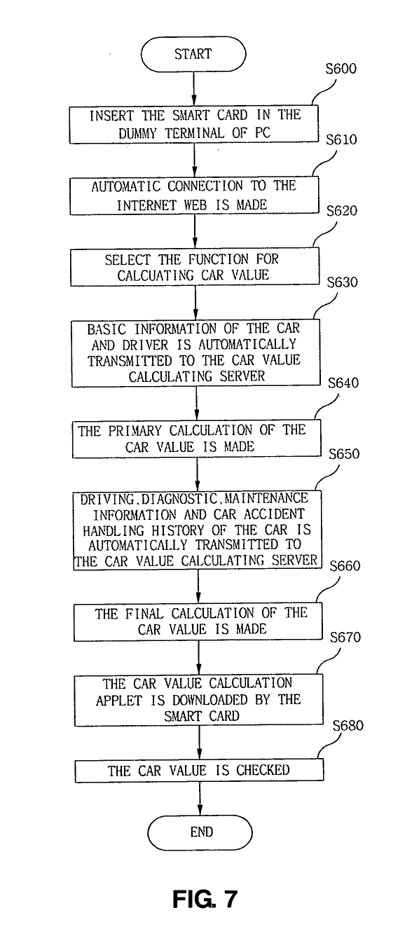

FIG. 7 is a flow chart showing a process of calculating a car value according to the present invention.

Referring to FIG. 6 and FIG. 7, the method of calculating a car value according to the present invention is described.

First, an applicant wanting the calculation of a car value inserts at the stage S600 the smart card 520 for cars into a dummy terminal of the PC 530, and then, a web browser of the PC 530 is automatically operated and connected to the car value calculating server 550, and a website of the server 550 pops up on the user's web browser at the stage S610.

Here, for the PC 530, any PC having a dummy terminal is sufficient, and it is not restricted to the PC, etc. of said person and the smart card 520 stores information on driving, diagnosis, maintenance and an accident history (by the processes of FIGS. 3 through 5) through the smart card control unit 512 of the car 510 and through the PCs in the body shops, hospitals, police station, etc. Also, the driver's personal information and basic car information is recorded.

The applicant selects a car value calculating function on the web site at the stage S620 and upon selection, the driver's personal and basic vehicle information is automatically transmitted at the stage S630 from the PC 530 to the car value calculating server 550.

Here, the basic car information and the driver's personal information that are automatically transmitted to the car value calculating server 550 include car information such as a vehicle identification number, a plate number, model, the year of manufacture, a fuel type, the number of cylinders, etc. and driver information such as said person's name, identification number, address, telephone number, gender, age, etc. Accordingly, it is not necessary for the car owner to manually input said information.

Then, the car value calculating server preliminarily calculates the car value based on the transmitted basic car information and the driver's basic information at the stage S640.

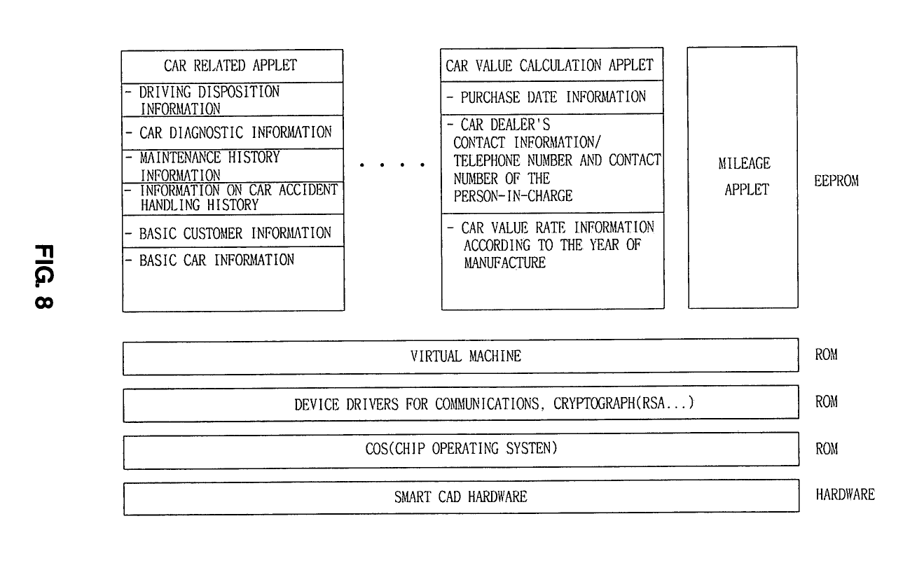

FIG. 8 is a drawing illustrating applets stored on a smart card according to the present invention.

Referring to FIG. 8, said basic car information and driver's personal information is recorded on the smart card 520 in the form of an applet.

After the preliminary calculation of said car value, the driving information (that is, the driver's driving disposition information), the diagnostic information of the car, the maintenance information of the car (including the period of expendable vehicle parts exchange) and the information on the car accident history that are read from the smart card 520 are automatically transmitted to the car value calculating server 550 at the stage S650.

Referring to FIG. 8, such driving, diagnostic, maintenance and car accident history information of the car is recorded on the smart card 520 in the form of an applet.

Then, the car value calculating server 550 secondarily calculates the car value based on said transmitted driving, diagnostic, maintenance and car accident history information. Based on this, the final car value calculation is made at the stage S660.

The secondary calculation of the car value based on said driving, diagnostic, maintenance and car accident history information of the car, is described with examples.

First, with regard to driving information, depending on the factors such as driving hours and speed according to the mileage and places of a driving (that is, highways or ordinary roads), cars driving on the highways can be in better condition than the cars moving around in town even if they have the same mileage.

Next, with regard to the diagnostic information of a car, defects of car parts can be a factor for weakening the function of a car, and if the conditions of an engine and various vehicle equipments are not good, it may also be a factor to decrease the value at the time of calculating a car value.

Also, with regard to car maintenance information (this information is inputted from the terminal at the body shop), the maintenance history regarding whether the maintenance has been made regularly or whether exchanges of oils and vehicle parts such as engine, transmission oils, tires, etc. are made regularly is a basis for calculating the car value.

Further, the information on the extent of the car damage from a car accident and on whether the parts are replaced and how the accident was handled may be bases for calculating a car value.

A car value is decided by the difference in values between the above information that may be the bases of calculating the car value and the predetermined standards. That is, the car value calculating server 550 has as its database information on the averages of each value of driving, diagnostic, maintenance and car accident history information, and the averages of each vehicle are compared to the information read from the smart card of a car so as to produce the secondary calculation of a car value.

That is, according to the present invention, both of the preliminary and secondary calculations of a car value are automatically carried out by the information read from the smart card without the applicant's manual input, and also the information on the driver's driving disposition, car diagnosis, car maintenance and car accident history that are not considered in the conventional car value calculation is used for the car value calculation.

Next, the car value calculation applets are downloaded from the car value calculating server 550 to the applicant's (person checking the car value) PC 530 and are recorded on the smart card 520 at the stage S670.

Next, the calculated final car value (price) can be shown on the monitor, etc. and accordingly, the applicant can check the current price of the car he or she is interested in S680.

The present invention was specifically illustrated and described based on the above examples; however, such illustration and description are used for examples, and a person having ordinary skill in the art to which the present invention pertains can make various modifications without deviating from the spirit and scope of the invention as defined in the claims accompanied herewith.

What is claimed:

1. A system for calculating a car value, comprising:
a smart card control unit which is included in a car and loads a smart card, configured to derive a driving information, a diagnostic information and a maintenance information from electronic/mechanical control equipments and sensors of the car, and to store the driving information, the diagnostic information and the maintenance information on a smart card;
a PC which is connected to a communication network by inserting the smart card to a terminal in the PC; and
a car value calculating server which is connected to the communication network, configured to calculate the car value of the car on the basis of the driving information, the diagnostic information and the maintenance information,
wherein the PC transmits the driving information, the diagnostic information and the maintenance information of the car to the car value calculating server through the communication network.

2. The system according to claim 1, wherein the maintenance information of the car is stored on the smart card by a terminal apparatus of a body shop where the car is repaired.

3. The system according to claim 1, wherein the accident history of the car is stored on the smart card, characterized in that the value calculation of the car is based on the accident history.

4. The system according to claim 1, wherein the driving information comprises at least one of the mileage data, the driving time data, and the driving speed data such as the average speed, sudden acceleration, sudden deceleration, or overspeed.

5. The system according to claim 1, wherein the diagnostic information comprises information on whether or not various kinds of apparatuses in the car are in good condition.

6. The system according to claim 1, wherein the maintenance information comprises the maintenance history on the exchange of expendable vehicle parts and/or spare parts.

7. The system according to claim 1, wherein the value calculation of the car is carried out by comparing the driving information, the diagnostic information and the maintenance information of the car stored on the smart card with specific standard values.

8. A method for calculating a car value, comprising:
inserting a smart card into a terminal of a PC and connecting a car value calculating server through a communication network, whereon a smart card stores a driving information, a diagnostic information and a maintenance information of a car;
transmitting the driving information, the diagnostic information and the maintenance information to the car value calculating server by the PC; and
calculating the car value on the basis of the driving information, the diagnostic information and the maintenance information by the car value calculating server.
